(19) United States
(12) Patent Application Publication
(10) Pub. No.: US 2010/0161943 A1
(43) Pub. Date: Jun. 24, 2010

(54) PROCESSOR CAPABLE OF POWER CONSUMPTION SCALING

(75) Inventors: Kwon Young Su, Daejeon (KR); Koo Bon Tae, Daejeon (KR); Eum Nak Woong, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/479,691

(22) Filed: Jun. 5, 2009

(30) Foreign Application Priority Data
Dec. 19, 2008 (KR) 10-2008-0130619

(51) Int. Cl. G06F 9/312; G06F 1/04; G06F 9/30

(52) U.S. Cl. 712/205; 713/600; 712/208; 712/E09.028; 712/E09.033

(57) ABSTRACT

The present invention relates to a processor capable of power consumption scaling, and more particularly, to a technique that variably controls the energy consumption of a processor according to the energy capacity being supplied by providing a pipeline register with a bypass function so as to control the operating frequency of the processor.

### CROSS-REFERENCE TO RELATED APPLICATIONS

This application claims the priority of Korean Patent Application No. 2008-130619 filed on Dec. 19, 2008 in the Korean Intellectual Property Office, the disclosure of which is incorporated herein by reference.

### BACKGROUND OF THE INVENTION

1. Field of the Invention

The present invention relates to a processor capable of power consumption scaling, and more particularly, to a technique that variably controls the energy consumption of a processor according to the energy capacity being supplied by providing a pipeline register with a bypass function so as to control the operating frequency of the processor.

2. Description of the Related Art

Distributed autonomous systems have an independent power supply, provide a judgment function and perform data transmission and reception. Examples of these distributed autonomous systems may include wireless sensor networks (WSNs) and smart dust devices.

The development of wireless sensor networks was originally motivated by military applications. Wireless sensor networks are now used for many applications, including environmental or meteorological monitoring, healthcare applications, and traffic control. Further, wireless sensor networks can be used to sense physical or environmental conditions, such as temperature, sound, vibration, pressure and movement, in numbers of locations.

Wireless sensor networks have limitations in that unlimited amounts of power cannot be supplied from external sources. Therefore, wireless sensor networks need to include energy harvesting (or energy scavenging) modules deriving energy from external sources, and wireless transceivers and processors for performing functions.

Even if harvested energy from photovoltaic devices can be supplied from external sources, charged energy capacity is variable over time.

Therefore, the energy consumption of processors needs to be dynamically controlled according to the charged energy capacity and the usable energy capacity. Thus, it is essential to develop a technique for operating a system even when sufficient energy is not supplied while maintaining the complicated processing performance of processors.

### SUMMARY OF THE INVENTION

An aspect of the present invention provides a processor capable of power consumption scaling that variably controls the energy consumption of a processor according to the energy capacity being supplied by providing a pipeline register with a bypass function so as to control the operating frequency of the processor.

According to an aspect of the present invention, there is provided a processor capable of power consumption scaling, the processor including: a plurality of functional units sequentially performing functions; a plurality of pipeline register sets provided between the plurality of functional units, storing calculation results of functional units corresponding to previous stages of a pipeline and having bypass functions; a system clock control unit supplying clock signals to the plurality of pipeline register sets; and a bypass control unit supplying a bypass signal to a pipeline register set selected according to predetermined conditions among the plurality of pipeline register sets.

The plurality of functional units may include: a prefetch functional unit making a request to read an instruction from an instruction memory; a fetch functional unit reading the instruction from the instruction memory; a decode functional unit decoding the instruction read out from the instruction memory; an access functional unit making a request to read an operand needed to execute the decoded instruction; a read functional unit reading the operand needed to execute the instruction from a memory; an execute functional unit executing the instruction using the read operand; and a write functional unit storing a result of the execution of the instruction in a memory.

Each of the pipeline registers forming each of the plurality of pipeline register sets may include: a D flip-flop; and a multiplexer selecting any one of an output of the D flip-flop and a signal being supplied to the pipeline register.

The multiplexer may select and output data stored in the D flip-flop when the bypass signal is inactive. The multiplexer may select and output the signal being supplied to the pipeline register when the bypass signal is active.

The system clock control unit may not generate a clock signal with respect to a pipeline register set for which the bypass signal is active.

The bypass control unit may control the energy consumption of the processor by supplying the bypass signal to the pipeline register set selected according to the predetermined conditions among the plurality of pipeline register sets when an available power level of an apparatus having the processor therein is less than a predetermined level.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating a processor capable of scaling power consumption according to an exemplary embodiment of the present invention;

FIG. 2 is a configuration view illustrating a pipeline register having a bypass function that is included in a processor capable of power consumption scaling according to an exemplary embodiment of the present invention;

FIG. 3 is a pipeline development view when bypass signals are inactive at all of the pipeline stages; and

FIG. 4 is a pipeline development view when bypass signals are inactive between a prefetch functional unit and a fetch functional unit and between an access functional unit and a read functional unit, and the rest are active.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

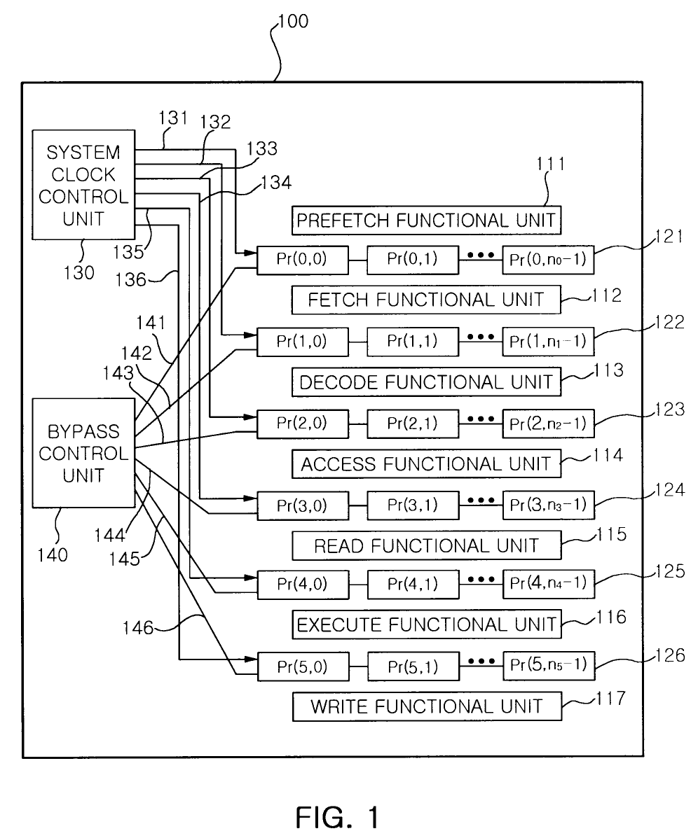

FIG. 1 is a configuration view illustrating a processor capable of power consumption scaling according to an exemplary embodiment of the invention.

A processor capable of power consumption scaling according to this embodiment includes a plurality of functional units 111, 112, 113, 114, 115, 116 and 117 sequentially performing functions thereof; a plurality of pipeline register sets 121, 122, 123, 124, 125 and 126 interposed between the plurality of functional units 111, 112, 113, 114, 115, 116 and 117, storing calculation results of the functional units corresponding to the previous stages, and each having a bypass function; a system clock control unit 130 supplying clock signals to the plurality of pipeline register sets 121, 122, 123, 124, 125 and 126; and a bypass control unit 140 supplying bypass signals to pipeline register sets selected among the plurality of pipeline register sets 121, 122, 123, 124, 125 and 126 according to predetermined conditions.

Specifically, the plurality of functional units 111, 112, 113, 114, 115, 116 and 117, performing the functions thereof in a sequential manner, include a prefetch functional unit 111 making a request to an instruction memory (not shown) to read an instruction, a fetch functional unit 112 reading an instruction from the instruction memory (not shown), a decode functional unit 113 decoding the instruction read out from the instruction memory (not shown), an access functional unit 114 making a request to read an operand needed to execute the decoded instruction, a read functional unit 115 reading the operand from a memory (not shown), an execute functional unit 116 executing the instruction using the read operand, and a write functional unit 117 storing a result of the execution of the instruction in a memory. Here, each of the plurality of functional units 111, 112, 113, 114, 115, 116 and 117 forms a pipeline stage of the processor.

The plurality of pipeline register sets 121, 122, 123, 124, 125 and 126 are interposed between the plurality of functional units 111, 112, 113, 114, 115, 116 and 117 forming individual pipeline stages of the processor. Each of the pipeline register sets 121, 122, 123, 124, 125 and 126 stores a calculation result of the functional unit corresponding to the previous pipeline stage.

In FIG. 1, each of the pipeline registers is referred to as Pr(i, j), where i denotes a pipeline stage, and j denotes an order of a pipeline register at the corresponding pipeline stage.

The number of pipeline registers may vary according to how a processor is implemented. In the embodiment, illustrated in FIG. 1, n₀ number of pipeline registers are disposed between the prefetch functional unit and the fetch functional unit, n₁ number of pipeline registers are disposed between the fetch functional unit and the decode functional unit, n₂ number of pipeline registers are disposed between the decode functional unit and the access functional unit, n₃ number of pipeline registers are disposed between the access functional unit and the read functional unit, n₄ number of pipeline registers are disposed between the read functional unit and the execute functional unit, and n₅ number of pipeline registers are disposed between the execution functional unit and the write functional unit.

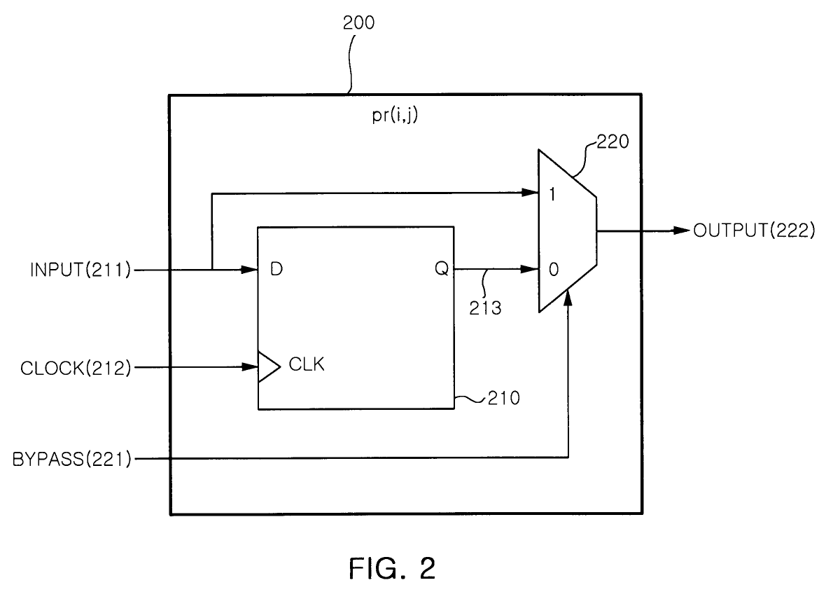

In this embodiment of the invention, each of the pipeline registers has a bypass function. A detailed configuration of the pipeline register having the bypass function will be described below with reference to FIG. 2.

The system clock control unit 130 generates and supplies clock signals 131, 132, 133, 134, 135 and 136 to the plurality of pipeline register sets 121, 122, 123, 124, 125 and 126, respectively. That is, the separate clock signals are respectively input to the plurality of pipeline register sets 121, 122, 123, 124, 125 and 126. Meanwhile, the system clock control unit 130 does not generate a clock signal with respect to a pipeline register set for which a bypass signal is active.

The bypass control unit 140 generates and supplies bypass signals to pipeline register sets selected according to predetermined conditions among the plurality of pipeline register sets 121, 122, 123, 124, 125 and 126.

As described above, the bypass control unit 140 does not supply bypass signals to all of the pipeline register sets but supplies bypass signals only to pipeline register sets selected according to the predetermined conditions, so that energy consumption can be variably controlled by adjusting an operating frequency of the processor 100 according to the available power level of an apparatus in which the processor 100 according to this embodiment operates. Therefore, when the energy consumption of the processor 100 needs to be adjusted since the available power level of the apparatus having the processor 100 mounted therein is less than a predetermined level, the bypass control unit 140 selectively supplies a bypass signal. The above-described predetermined conditions can be appropriately controlled according to which apparatus the processor 100 is mounted in.

As described above, the performance of the processor can be enhanced by configuring the processor in a way that the processor includes a plurality of pipeline stages. That is, functions corresponding to one instruction are performed according to pipeline stages to thereby increase an operating frequency. Furthermore, one instruction is executed on every clock signal to thereby improve throughput.

However, when a processor includes pipeline architecture, pipeline registers and a clock network for driving the pipeline registers consume a great deal of energy. In this embodiment, an operating frequency is controlled by controlling a pipeline according to the available power level of the apparatus, and thus, the energy consumption of the processor can be controlled.

FIG. 2 is a configuration view illustrating a pipeline register having a bypass function that is included in the processor capable of power consumption scaling of FIG. 1. A pipeline register 200 according to this embodiment includes a D flip-flop 210 and a multiplexer 220. A bypass signal from the bypass control unit 140, shown in FIG. 1, is supplied to the multiplexer 220.

The operation of the pipeline register 200, when a bypass signal 221 is inactive will be described. An input signal 211 of the pipeline register 200 is stored in the D flip-flop 210 according to a clock signal 212 being supplied from the system clock control unit 130, shown in FIG. 1. Data, stored in the D flip-flop 210, is selected by the multiplexer 220 and becomes an output 222 of the pipeline register 200.

On the other hand, the operation of the pipeline register 200 when the bypass signal 221 is active will be described. The input signal 211 of the pipeline register 200 is directly selected by the multiplexer 220 and becomes the output 222 of the pipeline register 200. Here, the output 222 of the pipeline register 200 has no relation to the clock signal 212. Therefore, the system clock control unit 130, shown in FIG. 1, does not generate a clock signal for a predetermined pipeline register set when a bypass signal is active.

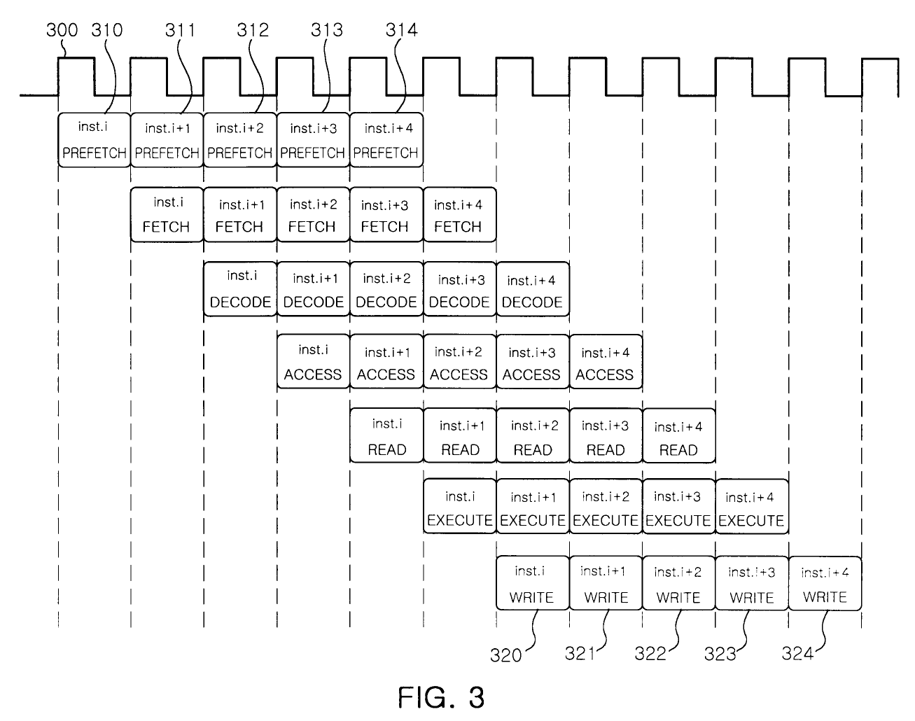

FIG. 3 is a pipeline development view when bypass signals are inactive at all the pipeline stages.

In FIG. 3, a clock signal 300 shows timings of clock signals at individual pipeline stages that are generated by the system clock control unit 130, shown in FIG. 1, when bypass signals are inactive at all of the pipeline stages. As shown in FIG. 3, when all of the bypass signals are inactive, all of the clock signals at the pipeline stages have the same timing.

Instructions 310, 311, 312, 313 and 314 are input to the prefetch functional unit 111, shown in FIG. 1, on every clock signal. Each time one clock signal passes, the instructions are passed to the next pipeline stages. As a result, when clock signals pass as many times as the number of pipeline stages, the instructions 320, 321, 322, 323 and 324 complete the final pipeline stage, that is, a write stage.

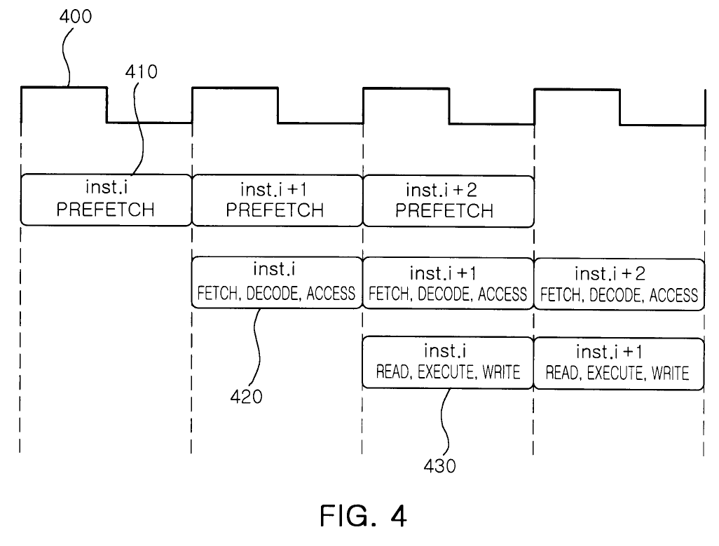

FIG. 4 is a pipeline development view when bypass signals are inactive between a prefetch functional unit and a fetch functional unit and between an access functional unit and a read functional unit, and the rest are active.

As shown in FIG. 4, when a bypass signal becomes selectively active or inactive, the system clock control unit 130, shown in FIG. 1, does not generate a clock signal for a pipeline register set in which a bypass signal is active but generates a clock signal for another pipeline register set in which a bypass signal is inactive.

In FIG. 4, a clock signal 400 shows timings of clock signals generated by the system clock control unit 130, shown in FIG. 1. As shown in FIG. 3, the clock signal 400 has an operating frequency equal to or less than one third of that of the clock signal 300.

Here, an instruction is input to the prefetch functional unit 111, shown in FIG. 1, on every clock signal. As shown in FIG. 4, the fetch, decode and access functional units 112, 113 and 114, as shown in FIG. 1, perform functions thereof at the next clock signal. Then, the read, execute and write functional units 115, 116 and 117, shown in FIG. 1, perform executions thereof at the following clock signal.

As described above, in the embodiment of the invention, bypass signals being supplied to pipeline registers at individual stages are controlled according to the energy supply conditions of an apparatus onto which a processor is mounted, so that an operating frequency of the processor is controlled and thus energy consumption of the processor can be controlled.

As set forth above, according to exemplary embodiments of the invention, bypass signals are supplied to some pipeline register sets according to the energy capacity being supplied, and clock signals corresponding to the pipeline register sets to which the bypass signals are supplied are inactivated, so that energy consumed by the pipeline registers and a clock network can be reduced.

Furthermore, since an operating frequency of a process is reduced by supplying bypass signals, an operating voltage of the processor is correspondingly reduced to thereby reduce the energy consumption of the processor.

While the present invention has been shown and described in connection with the exemplary embodiments, it will be apparent to those skilled in the art that modifications and variations can be made without departing from the spirit and scope of the invention as defined by the appended claims.

What is claimed is:

1. A processor capable of power consumption scaling, the processor comprising:
a plurality of functional units sequentially performing functions;
a plurality of pipeline register sets provided between the plurality of functional units, storing calculation results of functional units corresponding to previous stages of a pipeline and having bypass functions;
a system clock control unit supplying clock signals to the plurality of pipeline register sets; and
a bypass control unit supplying a bypass signal to a pipeline register set selected according to predetermined conditions among the plurality of pipeline register sets.

2. The processor of claim 1, wherein the plurality of functional units comprise:
a prefetch functional unit making a request to read an instruction from an instruction memory;
a fetch functional unit reading the instruction from the instruction memory;
a decode functional unit decoding the instruction read out from the instruction memory;
an access functional unit making a request to read an operand needed to execute the decoded instruction;
a read functional unit reading the operand needed to execute the instruction from a memory;
an execute functional unit executing the instruction using the read operand; and
a write functional unit storing a result of the execution of the instruction in a memory.

3. The processor of claim 1, wherein each of the pipeline registers forming each of the plurality of pipeline register sets comprises:
a D flip-flop; and
a multiplexer selecting any one of an output of the D flip-flop and a signal being supplied to the pipeline register.

4. The processor of claim 3, wherein the multiplexer selects and outputs data stored in the D flip-flop when the bypass signal is inactive.

5. The processor of claim 3, wherein the multiplexer selects and outputs the signal being supplied to the pipeline register when the bypass signal is active.

6. The processor of claim 1, wherein the system clock control unit does not generate a clock signal with respect to a pipeline register set for which the bypass signal is active.

7. The processor of claim 1, wherein the bypass control unit controls the energy consumption of the processor by supplying the bypass signal to the pipeline register set selected according to the predetermined conditions among the plurality of pipeline register sets when an available power level of an apparatus having the processor therein is less than a predetermined level.
